(19) United States
(12) Patent Application Publication
(10) Pub. No.: US 2025/0340381 A1
(43) Pub. Date: Nov. 6, 2025

(54) SOLAR TABLE RACK WITH OFF-LOADER

(71) Applicant: Terabase Energy, Inc., Berkeley, CA (US)

(72) Inventors: Grant Joseph Kimzey, Placerville, CA (US); Tyler Grushkowitz, Corvallis, OR (US); Noah James Wakeman Bystrom, Corvallis, OR (US); Adam Hansel, Davis, CA (US)

(73) Assignee: Terabase Energy, Inc., Berkeley, CA (US)

(21) Appl. No.: 18/653,526

(22) Filed: May 2, 2024

(51) Int. Cl. B65G 1/14; B65D 19/44; B65D 85/48

(52) U.S. Cl. CPC B65G 1/14; B65D 19/44; B65D 85/48; B65D 2519/00338; B65D 2519/0082

(57) ABSTRACT

Embodiments of a rack stack capable of holding multiple solar tables are described. The rack stack comprises one or more stackable solar table racks, with each solar table rack capable of holding more than one solar table. Each solar table may be supported by a pair of cantilevered beams such that the solar table may be unloaded from the rack in an unobstructed manner. The rack stack may be formed in a centralized factory and transported by a transportation vehicle, e.g., a mobile transport vehicle, a trailer, or a flatbed truck, to an offloading location near installation points of the solar tables. Solar tables in the rack stack may be fetched by a placer vehicle or a forklift via an end effector for installation. The ability of stacking multiple solar tables onto the rack stack improves solar table installation efficiency, especially for large solar farm constructions.

### TECHNICAL FIELD

The present disclosure relates generally to a solar table rack. More particularly, the present disclosure relates to a solar table rack and off-loader capable of stacking and fetching solar tables for improved transportation and installation efficiency.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is cost-effective management of the construction process and the ability to efficiently move components around the site during the construction process.

Large-scale solar panel systems typically include thousands of solar panels that are located across a multi-acre terrain and that are electrically coupled to provide a source of energy. These large-scale systems are oftentimes located in remote areas and require a significant investment in materials, resources, and labor in their installation and design. The sourcing and delivery of materials and resources for these installations can be problematic and inconsistent. A further complication is the reliable and safe movement of these materials and resources across large areas of the construction site as well as maintaining consistent installation processes at each point of installation within the site. These issues further contribute to an increase in the cost and complexity of a very cost-sensitive process.

FIG. 1 (FIG. 1) illustrates a typical prior-art installation process for solar systems. This prior-art installation process is implemented such that all mounting equipment for each solar panel is individually assembled and installed at its location within the larger system. The cost-effectiveness of this approach works fine within smaller solar deployments but struggles to cost-effectively scale to large solar systems as described below.

This traditional deployment 101 relies on materials delivered to a deployment site via an access road. The materials are then processed and staged at the deployment site by a crew. A small portion of this delivered material is then moved by heavy equipment to a specific location where a solar panel and mounting equipment are assembled and installed at that location 102. The step is repeated for an adjacent location 103 where materials are subsequently delivered, assembled, and installed for a neighboring solar table within the system. While this approach may be effectively deployed in the installation of smaller solar systems, it becomes cost-prohibitive as the size of the system increases.

What is needed are systems, devices, and methods that reduce the complexity and cost of installing large-scale solar panel systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. 1 shows a prior art assembly and installation process of large-scale solar panel systems.

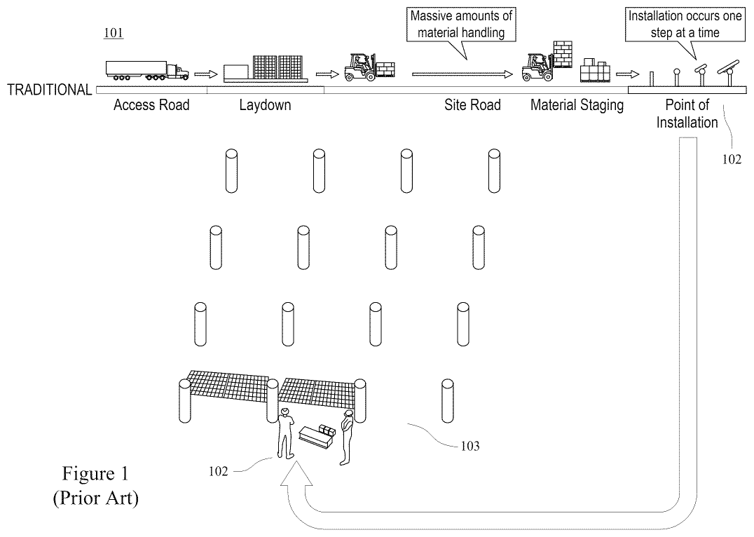

FIG. 2 is a diagram showing a centralized assembly and installation of a solar system using mobile transport of solar tables according to various embodiments of the invention.

FIG. 3 is a perspective view of a solar table rack for trailer or flatbed truck transportation according to various embodiments of the present invention.

FIG. 4 is another perspective view of a solar table rack for trailer or flatbed truck transportation according to various embodiments of the present invention.

FIG. 5 shows a tube hook, a wedge clamp, and a tube hook with hinged anti-rotational wings to secure a solar table on a solar table rack according to various embodiments of the present invention.

FIG. 6A is a perspective view of a stackable solar table rack according to various embodiments of the present invention.

FIG. 6B is a perspective view of an alternative stackable solar table rack according to various embodiments of the present invention

FIG. 7 is a perspective view of a rack stack comprising two solar table racks according to various embodiments of the present invention.

FIG. 8 is a perspective view of the stacked solar table racks according to various embodiments of the present invention.

FIG. 9 is a perspective view of an end effector facilitating solar table handling according to various embodiments of the present invention.

FIG. 10 is a perspective view of a placer vehicle to fetch a solar table from a solar table rack according to various embodiments of the present invention.

FIG. 11 is a process diagram of forming and transporting a solar table rack for installation according to various embodiments of the invention.

FIG. 12 is an illustration showing the different systems on which various embodiments of the invention may function.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion, components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of mechanical structures supporting corresponding functionalities of the solar table mobile transport.

Furthermore, connectivity between components or systems within the figures is not intended to be limited to direct connections. Also, components may be integrated together or be discrete prior to the construction of a solar panel mobile transport.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functions may be optional; (2) components or functions may not be limited to the specific description set forth herein; (3) certain components or functions may be assembled/combined differently across different solar table mobile transports; and (4) certain functions may be performed concurrently or in sequence.

Furthermore, it shall be noted that many embodiments described herein are given in the context of the assembly and installation of large numbers of solar tables within a system, but one skilled in the art shall recognize that the teachings of the present disclosure may apply to other large and complex construction sites in which resources and personnel are difficult to manage and accurately predict. Additionally, embodiments of a solar table rack may be used in smaller solar farm construction sites.

In this document, “large-scale solar system” refers to a solar system having 1,000 or more solar panels. The word “resources” refers to material, parts, components, equipment or any other items used to construct a solar table and/or solar system. The word “personnel” refers to any laborer, worker, designer, or individual employed to construct or install a solar table or solar system. The term “solar table” refers to a structural assembly comprising a torque tube and/or purlins with module rails. Some types of solar tables may have supplemental structure that allows them to connect to foundations/piles, while other types do not have this supplemental structure. A solar table may have (but is not required) one or more solar panels and/or electrical harnesses. The term “solar table mobile transport” (hereinafter, “mobile transport”) describes a vehicle used to move a solar table to an installation site and facilitate the installation process of the solar table. A mobile transport may be driven by personnel, controlled by remote control or move autonomously within at least a portion of a solar system construction site. The term “transport component” refers to a lower portion of the mobile transport that provides movement and includes wheels (or similar features such as tracks, a tractor assembly or robotic system), steering mechanism (autonomous or personnel driven) and braking mechanism.

In this document, the term “rack” is a structure to securely hold multiple preassembled solar tables. The rack may be loaded on a mobile vehicle to transport multiple solar tables at once, or on a trailer that is towed to a desired destination. The rack may or may not provide alignment capability for desired vertical, horizontal, and/or angular motions for a torque tube and/or solar table. The movement may be a manual or motorized motion. The term “motor” is defined as a structural device that produces motion, unidirectional or multidirectional, of a solar table. Examples of some motors may include elements such as actuators, tracks, etc. that help in producing motion of structures within the mobile transport or the solar table.

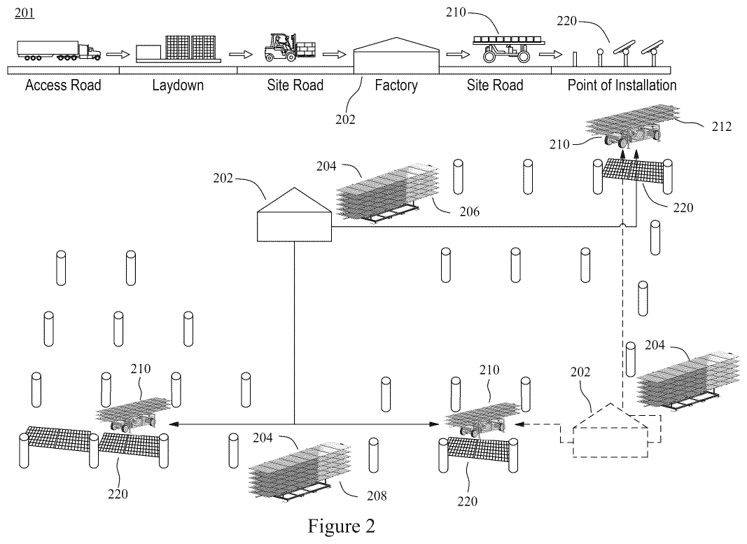

FIG. 2 provides an overview of a centralized solar table assembly and installation for large-scale solar systems according to various embodiments of the invention. Embodiments of the invention transition the prior art approach of assembly and installation at points of installation across the solar site to a centralized and coordinated assembly factory that allows a more cost-effective and dynamic process of constructing large-scale solar systems. This centralized assembly of solar system components, such as solar tables, necessitates a more robust transport vehicle to move the preassembled components to the installation site. Additionally, installation of these preassembled components may require functionality to support the alignment and integration of these components into the system. This alignment of a solar table secured on a mobile transport to a particular installation site may be aided by horizontal and/or vertical motion via one or more elements deployed on the mobile transport.

Resources are brought to construction site 201 for a large-scale solar system and initially processed. These resources are delivered to one or more assembly factories 202 where a coordinated and centralized solar table assembly process is performed. In certain embodiments, a construction site may have multiple centralized factories 202. As shown in FIG. 2, there are two centralized factories 202 strategically located at the site. The location and number of centralized factories 202 may depend on several parameters, including the size of the site, the terrain of the site, the design of the site, and other variables that relate to the construction of the large-scale solar system.

Solar tables may be preassembled at a centralized factory 202 and stacked in a solar table rack 204, which facilitates batch assembling of solar tables and also saves storage places for the centralized factory. The solar table rack 204 may be placed at the centralized factory 202 directly or a rack buffer area 206 near the the centralized factory 202 for a mobile transport 210 (also referred to as a mobile transport vehicle or MTV) to fetch one or more solar tables for transportation to the point of installation. Alternatively, the entire solar table rack 204 may be transported to an offloading location 208 near the point of installation where the tables are loaded to the MTV 210 for final installation. During the course of a solar farm construction, an MTV may need to travel back and forth between the centralized factory and various installation locations. Such traveling may be stretching and extensive, especially for a large solar farm construction site across a multi-acre terrain. Placing a solar table rack 204 holding multiple solar tables in an offloading location 208 near final points of installation would be more time-efficient for an overall installation process. The solar table rack 204 may be transported on a trailer or flatbed truck to the location 208, where the whole solar table rack 204 may be offloaded, or the solar tables are offloaded from the rack and installed by an MTV, a telehandler or forklift with picking attachment, or other special placer vehicles.

The MTV 210 may be specifically designed to transport one or more solar tables 212 from the solar table rack 204 for final installation. The MTV 210 may be driven by personnel, controlled by remote control, or autonomously driven by a computer system.

In embodiments, delivery of assembled solar tables to an installation site may require an alignment process to installation points at the installation site. Because an assembled solar table is often large and heavy, this alignment process may be complicated and require significant effort by personnel to properly align both ends of a solar table to receptors, piles, or other coupling elements at the installation site. Embodiments of the MTV may allow manual or motorized vertical/horizontal alignment of the solar table while it is still secured to the mobile transport. Specifically, the horizontal alignment capability also allows less precise positioning of the mobile transport at the installation site due to the horizontal movement capability of the solar table. As a result, the MTV may be parked proximate to the installation site without requiring precise parking to initiate an alignment and installation process.

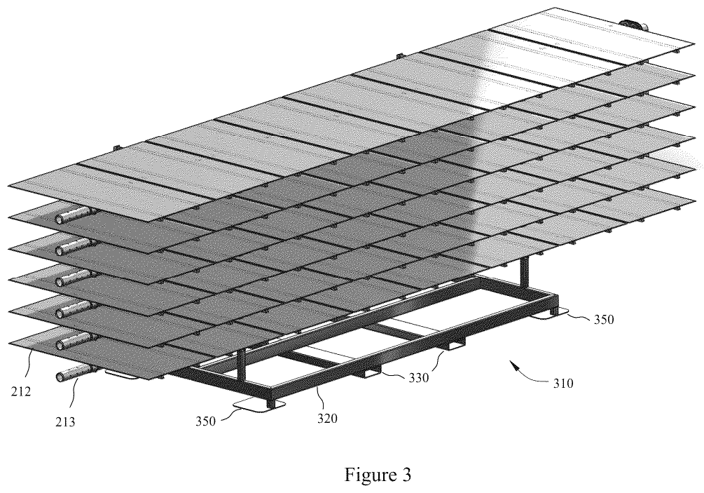

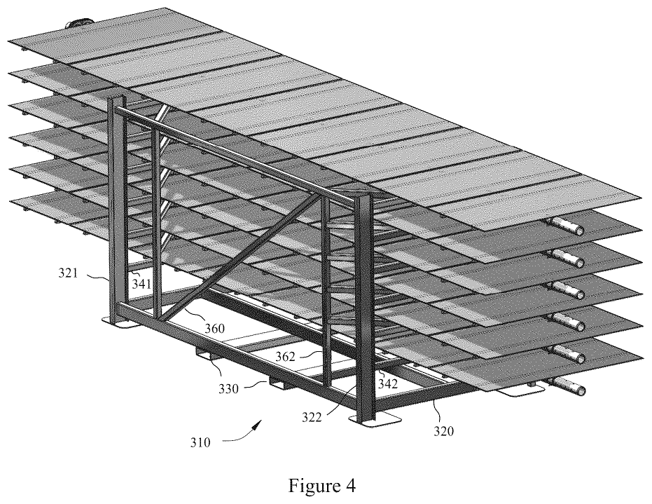

FIG. 3 and FIG. 4 depict different perspective views of a solar table rack for trailer or truck transportation according to various embodiments of the present invention. The solar table rack 310 may hold multiple preassembled solar tables 212 vertically stacked on the rack. With the capacity to hold multiple solar tables, the solar table rack provides a solution for improved solar table storing and transporting efficiency.

The solar table rack 310 comprises a base frame 320, a pair of vertical beams 321/322 coupled to the base frame 320, and multiple pairs of cantilevered beams, e.g., 341/342, attached to the pair of vertical beams 321/322 with each pair of cantilevered beam configured to support a toque tube 213 of a solar table 212. The rack 310 may also comprise a pair of forklift receiving sleeves 330 attached to the base frame 320 for receiving forks from a forklift such that the rack 310 may be lifted on top of a trailer or a flatbed truck for transportation to an offloading location in proximity of final installation points of the solar tables. Once arriving at the desired installation place, the rack 310 may be unloaded entirely to the ground first. Afterward, a placer vehicle may pick up a solar table from the rack for final installation.

In one or more embodiments, the solar table rack 310 may further comprise multiple supporting pads 350 that are coupled to the base frame 320 or the vertical beams 321/322. The supporting pads 350 provide stable support for the solar table rack 310, especially if the ground of the offloading location is muddy or loose. The solar table rack 310 may further comprise one or more reinforcement beams, e.g., 360/362, for structural reinforcement of the vertical and supporting beams.

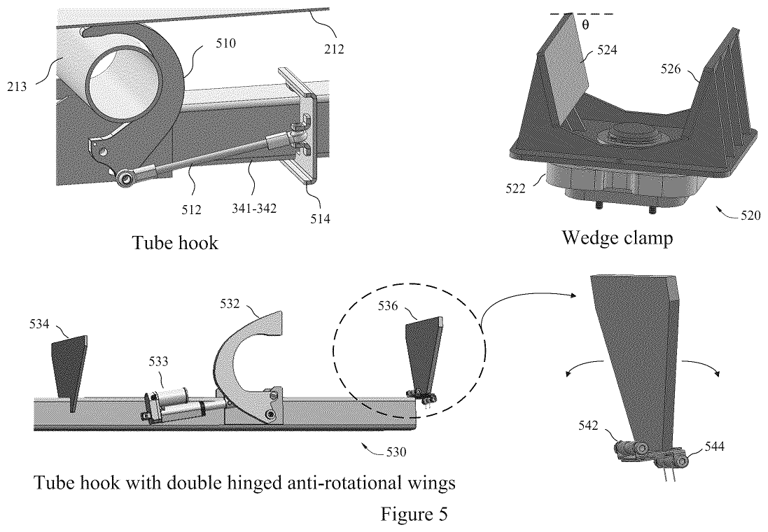

Solar tables can be securely held on the solar table rack. FIG. 5 shows a tube hook, a wedge clamp, and a tube hook with hinged anti-rotational wings to secure a solar table on a solar table rack according to various embodiments of the present invention. As shown in FIG. 5, a tube hook 510 is placed on each cantilevered beam. The tube hook may be rotatable to engage the torque tube 213 of the solar table 212 firmly. It may collaborate with additional components, such as anti-rotational wings placed on both sides of the tube hook, to provide stable and secure support for the solar table during transportation. The tube hook 510 may be actuated by a locking knob 514 through a control link 512 to lock the torque tube securely in place.

Besides a tube hook, various other means, e.g., a C-clamp or a wedge clamp, may be used for secure tube support. For example, a C-clamp comprising a pair of cradle surfaces may be used to support a torque tube. The C-clamp may be tightened or compressed such that the pair of cradle surfaces firmly hold the torque tube in place. The friction force between the cradle surfaces and the torque tube may prevent the torque tube from rotating during transportation. The C-clamp may be used alone or in collaboration with the anti-rotation wings.

FIG. 5 also depicts a wedge clamp to hold a torque tube securely. The wedge clamp 520 comprises a clamp base 522 for attaching the wedge clamp to a cantilevered beam, a first clamp surface 524, and a second clamp surface 526. The first clamp surface 524 and the second clamp surface 526 form a high-angle cradle to receive a torque tube. When the torque tube is laid down between the first and second clamp surfaces, the gravity of the torque tube (and also the solar panels attached to the torque tube) drags the torque tube downward. The high-angle cradle is very effective in amplifying the gravity force with an amplification factor to a normal force to hold the torque tube securely and prevent tube rotation. Depending on the geometry, the amplification factor may be related to the tangent of the vertical angle θ of the clamp surfaces. For example, the amplification factor may be 2.75) (tan 70° at a 70° vertical angle, 11.4) (tan 80° at an 80° vertical angle, or even go to infinity as the angle @ approaches 90°. Such gravity force amplification may be effective and adequate to hold the torque tube securely during transportation without involving extra anti-rotation rings.

FIG. 5 also depicts a tube hook with hinged anti-rotational wings to secure a solar table on a solar table rack. A tube hook 530 is placed on each cantilevered beam to rotatably engage a torque tube. The tube hook 530 has two anti-rotational wings 534/536 placed on both sides to provide stable and secure support for the solar table during transportation. The tube hook 530 may be coupled to a strut 533 for hook engagement control. In one or more embodiments, the outward anti-rotational wings 536 may be a passive two-way hinged wing controlled by a saloon hinge comprising a pair of torsion hinges 542/544 to allow wing swing in both directions such that a solar table may be loaded and fetched horizontally without needing to be lifted above the anti-rotational wings 536 first. Such an embodiment is advantageous to allow solar tables to be stacked space-efficiently without requiring excessive vertical clearance between stacked tables.

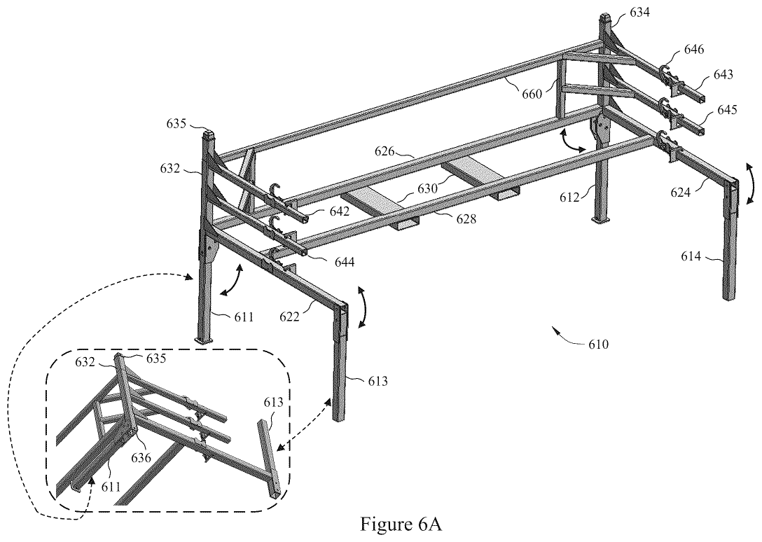

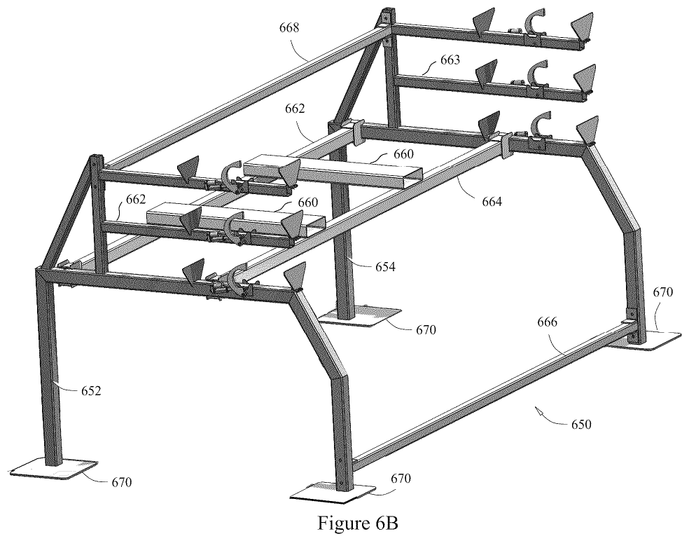

FIG. 6A is a perspective view of a stackable solar table rack according to various embodiments of the present invention. The solar table rack 610 comprises a plurality of rack legs 611˜614, a base frame comprising a pair of support beams 622/624 and a pair of connection beams 626/628 coupled between the support beams for structural connection, a pair of stackable beams 632/634 extending upward from the base frame (e.g., from legs 611 and 612), and multiple cantilevered beams, e.g., 642˜645, coupled to each stackable beam. The rack legs enable the rack to stand by itself and allow a transport rover to be parked underneath the pair of support beams to lift up and transport the rack. The cantilevered beams are stacked vertically and form multiple pairs (e.g., 642/643 or 644/645) of cantilevered beams, with each pair designated to support one solar table. The pair of support beams 622/624 may also be configured to support one solar table. The cantilever layout ensures that solar tables may be loaded or unloaded in an unobstructed manner from an open side. The solar table rack 610 may further comprise one or more reinforcement beams 660 for structural reinforcement to the support beams and the cantilevered beams.

A tube hook 646 (or a wedge clamp) is placed on each support beam and each cantilevered beam. The tube hook is rotatable to engage a torque tube of a solar table alone or in collaboration with anti-rotational wings (not shown in FIG. 6) placed on both sides of the tube hook to provide stable and secure support for the solar table during transportation. The solar table rack 610 may also comprise a pair of forklift receiving sleeves 630 that are attached to the base frame for receiving forks from a forklift such that the rack 610 may be lifted and placed on top of a solar panel mobile transport vehicle.

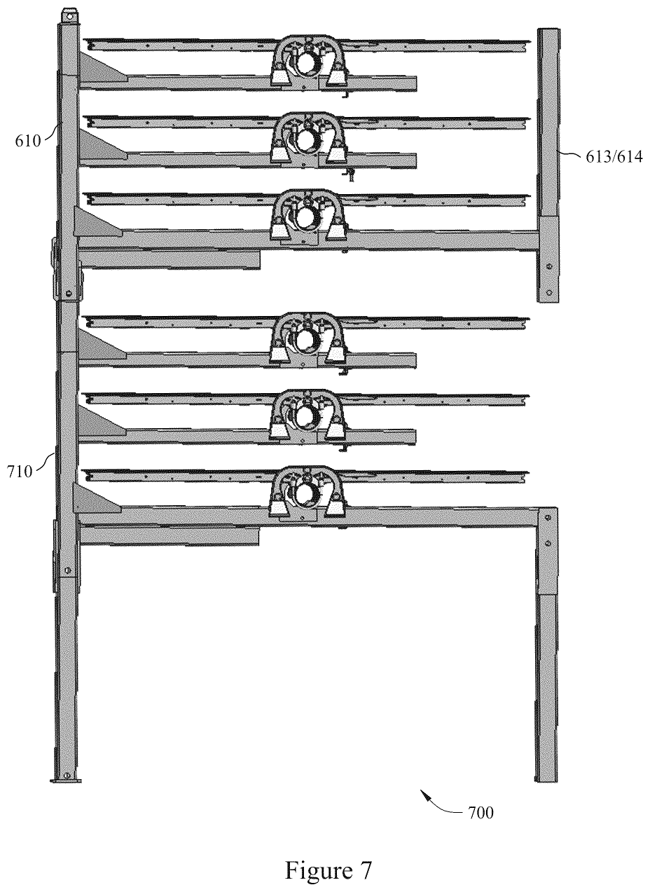

Each stackable beam 632 has a top end 635 and a bottom end 636 that is hollow and configured to receive the top end of a stackable beam from another solar table rack. The plurality of rack legs 611˜614 are foldable such that the solar table rack 610 may be stacked over another solar table rack 710 to form a rack stack 700. The rack legs may be folded sideward (611/612) or backward (613/614). When the rack legs 611/612 are folded, the bottom ends of both stackable beams are exposed for receiving corresponding top ends of stackable beams from another solar table rack, as shown in FIG. 7.

FIG. 6B is a perspective view of an alternative stackable solar table rack according to various embodiments of the present invention. The solar table rack 650 comprises a first side frame 652 and a second side frame 654, and multiple connection beams 626˜628 coupled between the side frames for structural connection. The side frames 652/654 have a structure approximate to an inverted U-shape with a connection arm on top and two arms extending downward. Multiple cantilevered beams, e.g., 662 and 663, are disposed on each side frame. These cantilevered beams are stacked vertically and form multiple pairs (e.g., 662/663) of cantilevered beams, with each pair designated to support one solar table. Each cantilevered beam has a tube hook and two anti-rotational wings placed on both sides of the tube hook, in a layout similar to the tube hook with hinged anti-rotational wings depicted in FIG. 5. The tube hook is rotatable to lock a torque tube of a solar table with additional support by the anti-rotational wings to provide stable and secure support for the solar table during transportation. A pair of forklift receiving sleeves 660 are attached to the connection beams 662/664 for receiving forks from a forklift such that the rack 650 may be lifted for transportation. The solar table rack 650 may further comprise multiple supporting pads 670 that are coupled to the side frame 652/654. The supporting pads 350 provide stable support for the solar table rack 650, especially if the ground of the offloading location is muddy or loose.

FIG. 7 is a perspective view of a rack stack 700 comprising two solar table racks according to various embodiments of the present invention. The rack stack 700 may be transported by a flatbed truck or an excavator to an offloading location in proximity to final installation points of the solar tables. During transportation, especially on a flatbed truck, the rack legs of the lower solar table rack 710 may be folded such that the rack stack 700 may have a lower center of gravity for stability. During offloading, the rack legs of the lower solar table rack 710 may be unfolded such that the rack stack 700 may stand by itself for the convenience of solar table fetching. Specifically, since solar tables on the lower solar table rack 710 are unobstructed by rack legs, a solar table installation vehicle may fetch a solar table (stacked on the solar table rack 710) directly from the rack stack 700 for final installation, without needing unstacking the rack stack 700. Therefore, installation efficiency may be further improved.

Once all solar tables on the solar table rack 710 are fetched, an on-site installer may unfold the rack legs 613/614 downward, such that the solar tables on the rack 610 may be fetched unobstructively. Such unfolding would be effortless since the rack legs 613/614 are freestanding without mechanical load.

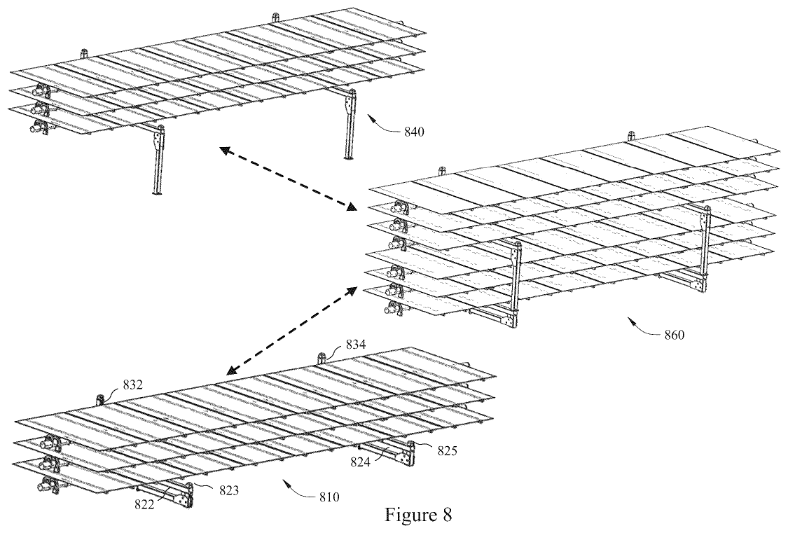

FIG. 8 is a perspective view of the stacked solar table racks according to various embodiments of the present invention. The solar table racks 810/840 may have a structure mostly similar to the solar table rack 610 shown in FIG. 6. Therefore, the structural descriptions for the solar table rack 610 may also apply to the solar table racks 810/840. Similar to the solar table rack 610, the solar table rack 810 comprises a pair of stackable beams 832/834, with each stackable beam having a top end and a bottom end that is hollow and configured to receive a top end of a stackable beam from another solar table rack. The solar table rack 810 has a pair of the support beams 822/824, each of which has a stacking tip 823/825 similar to the top end of each stackable beam and configured to engage a rack leg from another solar table rack 840 for rack stacking. As a result, the solar table racks 810 and 840 may be stacked into a rack stack 860 for transportation. For stability, the rack legs of the lower solar table rack 810 may be folded for a lower center of gravity during transportation and unfolded for rack support. Furthermore, since the solar tables on the upper solar table rack 840 are unobstructed by rack legs, a solar table installation vehicle may fetch a solar table (on the solar table rack 840) directly from the rack stack 860 for final installation without needing to unstack the rack stack 860.

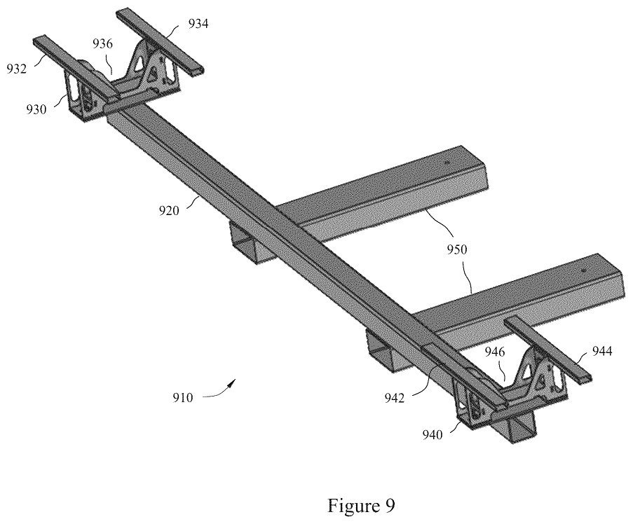

Once transported and offloaded to an offloading location near the final installation point, a solar table may be fetched by a placer vehicle from the solar table rack or the rack stack. FIG. 9 is a perspective view of an end effector facilitating solar table handling according to various embodiments of the present invention. The end effector 910 functions as a fetching tool such that a generic placer vehicle, such as a forklift, may fetch a solar table using the fetching tool. Accordingly, the end effector 910 provides a compact and cost-effective solution for a generic placer vehicle, such as a forklift, to fetch a solar table.

As shown in FIG. 9, the end effector 910 comprises a support bar 920, a first tube holder 930 placed on a first end of the support bar, a second tube holder 940 placed on a second end of the support bar, and a pair of forklift receiving sleeves 950 securely attached to the support bar 920. For example, the forklift receiving sleeves may be connected via soldering, structure welding, or a bolted connection for a strong and permanent connection. The first and second tube holders may have a groove or indentation to hold a torque tube of a solar table. Additionally, the first tube holder 930 may also have a first pair of anti-rotational bars 932/934 placed on both sides of the groove 936, and the tube holder 940 may also have a second pair of anti-rotational bars 942/944 placed on both sides of the groove 946. The anti-rotational bars ensure that the solar table may be held stably without rotation when fetched from the solar table rack.

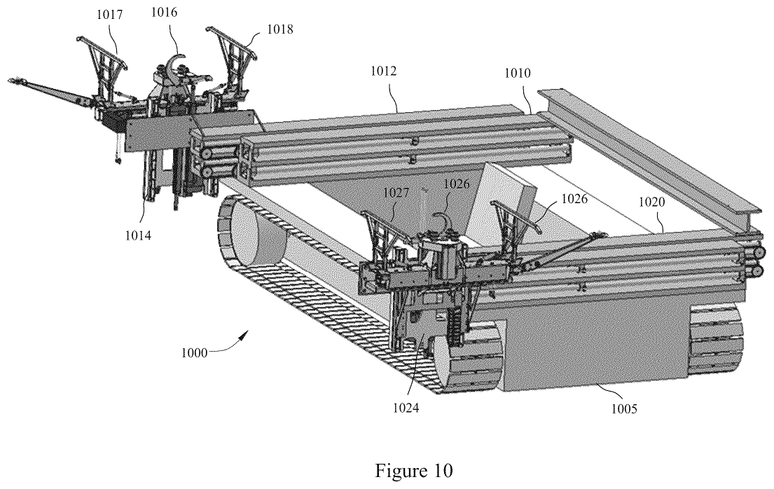

FIG. 10 is a perspective view of a placer vehicle to fetch a solar table from a solar table rack according to various embodiments of the present invention. The placer vehicle 1000 comprises a base vehicle 1005 to provide movement, a pair of support rails 1010/1020, a pair of sliding rails 1012/1022 slidably attached to respective support rails, a pair of vertical motion elements 1014/1024 slidably attached to respective sliding rails to enable vertical motion, and a pair of tube hooks 1016/1026 placed on respective vertical motion elements 1014/1024. The base vehicle 1005 may use tracks, as shown in FIG. 10, for enhanced maneuverability, especially when the installation site is loose or muddy.

The pair of sliding rails 1012/1022 enable horizontal motion to fetch or install a solar table. The sliding rail 1012/1022 may have a motorized track that moves the sliding rail along respective support rails 1010/1020. The vertical motion elements 1014/1024 provide vertical movement for height adjustment to fetch or install a solar table. One skilled in the art will recognize that the sliding rail or the vertical motion elements may be realized in various structures and motorized or manually controlled by personnel.

The pair of tube hooks 1016/1026 are used to hold a torque tube of a solar table securely during the fetching or installation process. A first pair of anti-rotational wings 1017/1018 are placed on both sides of the tube hook 1016 and a second pair of anti-rotational wings 1027/1028 are placed on both sides of the tube hook 1026 to provide stable and secure support for the corresponding solar table during the fetching or installation process.

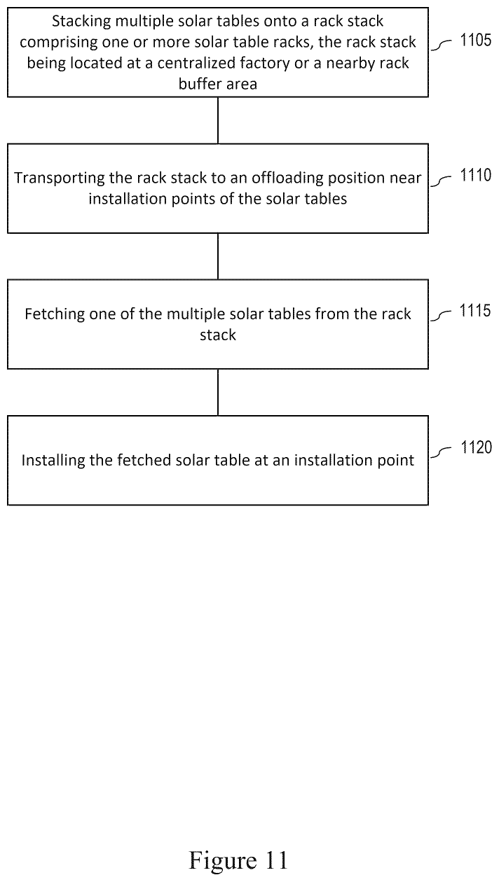

FIG. 11 is a process diagram of forming and transporting a solar table rack for installation according to various embodiments of the invention. In step 1105, multiple solar tables are stacked, at a centralized factory or a nearby rack buffer area, on a rack stack that comprises one or more solar table racks. Each solar table rack may stack more than one solar table.

In step 1110, the rack stack is transported by a transportation vehicle, e.g., a mobile transport vehicle, a trailer, or a flatbed truck, to an offloading location near the installation points of the solar tables for rack track offloading. In step 1115, one of the multiple solar tables is fetched from the rack stack. The solar table may be fetched by a forklift via an end effector or a placer vehicle from the rack stack at the offloading location. In step 1120, the fetched solar table is installed at an installation point. The installation may be implemented by the forklift via the end effector or the placer vehicle.

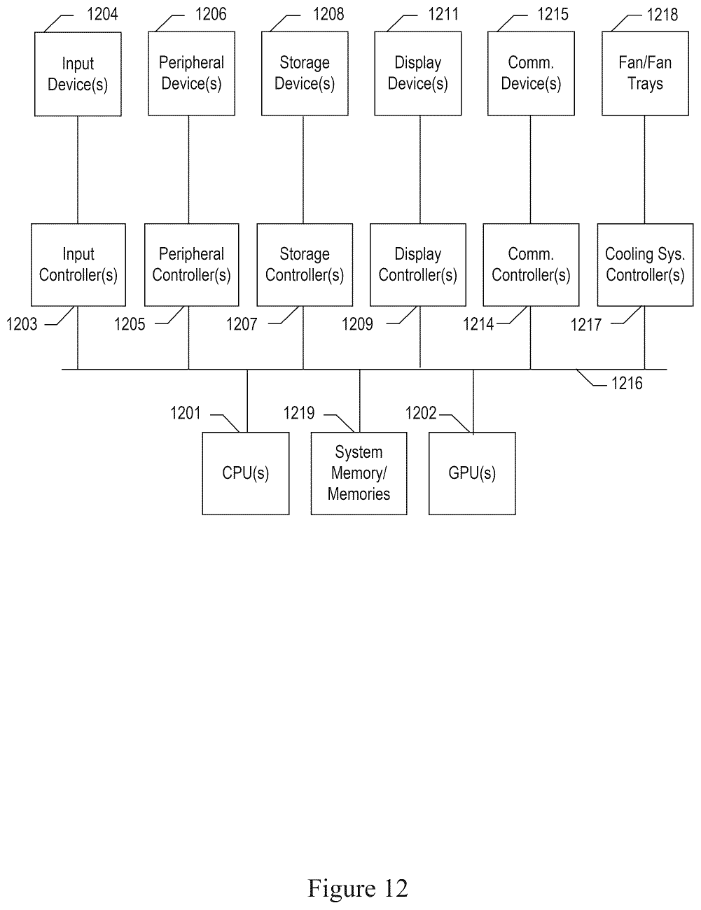

FIG. 12 depicts a simplified block diagram of a computing device/information handling system (or computing system) according to embodiments of the present disclosure, such as for a computer system autonomously driving the MTV 210. It will be understood that the functionalities shown for system 1200 may operate to support various embodiments of a computing system—although it shall be understood that a computing system may be differently configured and include different components, including having fewer or more components as depicted in FIG. 12.

As illustrated in FIG. 12, the computing system 1200 includes one or more central processing units (CPU) 1201 that provides computing resources and controls the computer. CPU 1201 may be implemented with a microprocessor or the like and may also include one or more graphics processing units 12112 and/or a floating-point coprocessor for mathematical computations. System 1200 may also include a system memory 1202.

A number of controllers and peripheral devices may also be provided, as shown in FIG. 12. An input controller 1203 represents an interface to various input device(s) 1204, such as a keyboard, mouse, touchscreen, and/or stylus. The computing system 1200 may also include a storage controller 1207 for interfacing with one or more storage devices 1208 each of which includes a storage medium such as flash memory or disk memory or RAM/ROM memory, or an optical medium that might be used to record programs of instructions for operating systems, utilities, and applications, which may include embodiments of programs that implement various aspects of the present invention. Storage device(s) 1208 may also be used to store processed data or data to be processed in accordance with the invention. The system 1200 may also include a display controller 1209 for providing an interface to a display device 1211, which may be a cathode ray tube, a thin film transistor display, organic light-emitting diode, electroluminescent panel, plasma panel, or other type of display. The computing system 1200 may also include one or more peripheral controllers or interfaces 1205 for one or more peripherals. Example of peripheral may include one or more printers, scanners, input devices, output devices, sensors, and the like. A communications controller 1214 may interface with one or more communication devices 1215, which enables the system 1200 to connect to remote devices through any of a variety of networks including the Internet, a cloud resource (e.g., an Ethernet cloud, a Fiber Channel over Ethernet/Data Center Bridging cloud, etc.), a local area network, a wide area network, a storage area network, or through any suitable electromagnetic carrier signals including infrared signals. Cloud or wireless controller 1217 may also be provided that interface with various cloud or wireless devices 1218.

In the illustrated system, all major system components may connect to a bus, which may represent more than one physical bus. However, various system components may or may not be in physical proximity to one another. For example, input data and/or output data may be remotely transmitted from one physical location to another. In addition, programs that implement various aspects of the invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Aspects of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A solar table rack comprising:
a base frame:
a pair of vertical beams coupled to the base frame; and
multiple pairs of cantilevered beams attached to the pair of vertical beams to support multiple solar tables, the multiple pairs of cantilevered beams are stacked vertically, each pair of cantilevered beams is configured to support one of the multiple solar tables, each solar table comprises a torque tube and one or more solar panels attached to the torque tube.

2. The solar table rack of claim 1 wherein each cantilevered beam comprising:
a tube hook that is rotatable to lock a torque tube of a corresponding solar table; or
a wedge clamp to support a torque tube of a corresponding solar table.

3. The solar table rack of claim 1 further comprising:
one or more reinforcement beams for structural reinforcement of the solar table rack.

4. The solar table rack of claim 1 further comprising:
a pair of forklift receiving sleeves attached to the base frame to receive forks from a forklift for solar table rack transportation.

5. The solar table rack of claim 1 further comprising:
multiple supporting pads coupled to the base frame and/or the vertical beams to provide a stable support for the solar table rack.

6. A solar table rack stack comprising:
a first solar table rack comprising:
a first base frame;
a first pair of stackable beams extending upward from the first base frame; and
a first plurality of cantilevered beams coupled to each of the first pair of stackable beam; and
a second solar table rack stacked above the first solar table rack, the second solar table rack comprising:
a second base frame;
a second pair of stackable beams extending upward from the second base frame, each of the second pair of stackable beams has a bottom end that is hollow and configured to stack on a top end of one of the first pair of stackable beams from the first solar table rack; and
a second plurality of cantilevered beams coupled to each of the second pair of stackable beam; and
wherein the first and the second plurality of cantilevered beams are configured to support multiple solar tables, each solar table comprises a torque tube and one or more solar panels attached to the torque tube.

7. The solar table rack stack of claim 6 wherein the first and the second solar table racks further comprises one or more reinforcement beams for structural reinforcement.

8. The solar table rack stack of claim 6 wherein each of the first and second plurality of cantilevered beams comprises a tube hook that is rotatable to lock a torque tube of a corresponding solar table.

9. The solar table rack stack of claim 6 wherein the first solar table rack further comprising:
a pair of forklift receiving sleeves attached to the first base frame to receive forks from a forklift for rack stack transportation.

10. The solar table rack stack of claim 6 wherein the first solar table rack further comprising:
a first pair of rack legs that are foldable, the pair of rack legs are folded for transportation stability and unfolded to support the solar table rack stack.

11. The solar table rack stack of claim 10 wherein the second solar table rack further comprising:
a second plurality of rack legs that are foldable, when the second plurality of rack legs are folded, the bottom ends of the second pair of stackable beams are exposed for receiving corresponding top ends of the first pair of stackable beams from the first solar table rack.

12. The solar table rack stack of claim 11 wherein the first base frame comprises a pair of support beams and a pair of connection beams coupled between the pair of support beams for structural connection.

13. The solar table rack stack of claim 12 wherein each of the pair of support beams has a stacking tip configured to engage one of the second plurality of rack legs for structural supporting the second solar table rack.

14. A system for handling multiple solar tables, the system comprising:
a solar table rack stack comprising multiple pairs of cantilevered beams stacked vertically to support multiple solar tables, each pair of cantilevered beams is configured to support one of the multiple solar tables, each solar table comprises a torque tube and one or more solar panels attached to the torque tube; and
an end effector comprising a support bar, a first tube holder placed on a first end of the support bar, a second tube holder placed on a second end of the support bar, and a pair of forklift receiving sleeves securely attached to the support bar; and
wherein the first tube holder and the second tube holder are configured to hold a torque tube of one solar table among the multiple solar tables to fetch the one solar table from the solar table rack stack for installation.

15. The system of claim 14 wherein the first tube holder has a first groove and the second tube holder has a second groove for holding the torque tube.

16. The system of claim 15 wherein the first tube holder has a first pair of anti-rotational bars placed on both sides of the first groove, and the second tube holder has a second pair of anti-rotational bars placed on both sides of the second groove.

17. The system of claim 14 wherein the solar table rack stack comprises a pair of sleeves to receive forks from a forklift for solar table rack transportation.

18. The system of claim 14 wherein the solar table rack stack comprises a first solar table rack and a second solar table rack stacked above the first solar table rack, the multiple pairs of cantilevered beams are distributed between the first and the second solar table racks.

19. The system of claim 18 wherein each of the first and the second solar table racks comprises a plurality of rack legs that are foldable.

20. The system of claim 19 wherein:
the first solar table rack further comprises a first pair of stackable beams for cantilevered beam attachment; and
the second solar table rack further comprises a second pair of stackable beams for cantilevered beam attachment, each of the second pair of stackable beams has a bottom end that is hollow and configured to stack on a top end of one of the first pair of stackable beams from the first solar table rack.
